(19) United States
(12) Patent Application Publication
(10) Pub. No.: US 2003/0090024 A1
(43) Pub. Date: May 15, 2003

(54) Method and apparatus for separating molded articles

(75) Inventors: Erik L. Skov, Akron, OH (US); Gregory S. Floyd, Wooster, OH (US)

Correspondence Address: Bryan L. Lempia, Marshall, Gerstein & Borun, 6300 Sears Tower, 233 South Wacker Drive, Chicago, IL, 60606-6357, US

(73) Assignee: Rubbermaid Incorporated

(21) Appl. No.: 09/993,214

(22) Filed: Nov. 14, 2001

(51) Int. Cl. B29C 49/00

(52) U.S. Cl. 264/157; 264/527; 425/527; 425/806; 425/302.1

(57) ABSTRACT

A method of making molded components including supplying a plastic material to a mold to form a molded article and actuating a separating apparatus to at least partially separate the molded article into at least two components. An apparatus for making molded components including a cavity, a separating apparatus coupled to the cavity and configured to at least partially separate a molded article into at least two components.

### FIELD OF THE INVENTION

The present invention relates to a method and apparatus for separating molded articles.

### BACKGROUND OF THE INVENTION

It is generally known to mold a plurality of articles using a single mold having a plurality of cavities, one for each article being molded. An example of such known articles is a blow molded refuse container having a body and a lid that are molded during a single mold cycle. During such molding operations, the plurality of articles are connected by a plastic member (e.g., a “runner,” “flash,” a wall or rib, etc.). After the molding operation, the plurality of articles are removed from the mold and separated from one another in one or more post-molding operations (e.g., trimming with hand-tools, cutting machines). Sometimes the plurality of molded articles are secured in a fixture before substantial labor is used to separate them.

Such known methods present several disadvantages, such as the cost and time needed to separate items (particularly where they are first secured in a fixture), the restrictive tolerances or precision required for separating some molded articles, the potential for visual defects or imperfections caused by inconsistent post-molding operations, the costs of skilled labor for inspection, repair, quality control, and the like.

To provide an inexpensive, reliable and widely adaptable method and apparatus for separating molded articles to avoid the above-referenced and other problems would represent a significant advance in the art.

### SUMMARY OF THE INVENTION

A primary feature of the present invention is to provide an efficient method and apparatus that provides aesthetically-pleasing separated articles that overcomes the above-noted disadvantages.

Another feature of the present invention is to provide an apparatus that separates or partially separates a molded article while inside the mold and prior to removal of it.

Another feature of the present invention is to eliminate or simplify post-molding operations, and to make any such operations safer.

Another feature of the present invention is to automate post molding operations.

How these and other advantages and features of the present invention are accomplished (individually, collectively, or in various subcombinations) is described in the following detailed description of the preferred and other exemplary embodiments, taken in conjunction with the FIGURES. Generally, however, they may be accomplished in a method of making a molded article that includes the steps of supplying a plastic material to a mold to form the molded article, and moving a separating apparatus located in the mold to at least partially separate the molded article into at least two components.

These and other advantages and features of the present invention may also be accomplished in a method of making a molded article that includes the steps of forming the molded article in a mold, at least partially separating a first portion from a second portion, and then opening the mold.

These and other advantages and features of the present invention may also be accomplished in an apparatus for making a molded article that includes a cavity configured to provide a contoured surface for the molded article, a separating apparatus coupled to the cavity and configured to at least partially separate the molded article into at least two pieces.

The present invention further relates to various features and combinations of features shown and described in the disclosed embodiments. Other ways in which the objects and features of the disclosed embodiments are accomplished will be described in the following specification or will become apparent to those skilled in the art after they have read this specification. Such other ways are deemed to fall within the scope of the disclosed embodiments if they fall within the scope of the claims which follow.

### DESCRIPTION OF THE FIGURES

FIG. 1 is a perspective view of a blow mold cavity with an apparatus for separating molded articles according to a preferred embodiment.

FIG. 2 is a fragmentary perspective view of the mold cavity of FIG. 1.

FIG. 3 is a fragmentary perspective view of the separating apparatus of FIG. 2.

FIG. 4 is a top perspective view of the apparatus for separating blow molded articles of FIG. 1 according to a preferred embodiment.

FIG. 5 is a bottom perspective view of the apparatus for separating blow molded articles of FIG. 4.

FIG. 6 is a top plan view of the apparatus for separating blow molded articles of FIG. 4.

FIG. 7 is a front view of the apparatus for separating blow molded articles of FIG. 4.

FIG. 8 is a side section view of the apparatus for separating blow molded articles of FIG. 6 taken along the line 8-8 thereof.

FIG. 9 is a perspective view of a cutting member for the separating apparatus of FIG. 3 according to a preferred embodiment.

FIG. 10 is a side elevation view of a blow molding a machine with a preform located between a pair of sectioned mold cavities with an apparatus for separating molded articles.

FIG. 11 is a side elevation view of the molding machine of FIG. 4 with the mold closed and the preform expanded against the cavities according to a preferred an exemplary embodiment.

FIG. 12 is a top sectional view of the mold of FIG. 6 taken along line 12-12 thereof.

FIG. 13 is a side sectional view of a separated blow molded article according to a preferred embodiment.

FIG. 14 is a side sectional view of a mold cavity with a an apparatus for separating molded articles according to an alternative embodiment.

FIG. 15 is perspective view of one mold cavity with an apparatus for separating molded articles according to an alternative embodiment.

FIG. 16 is a fragmentary view of a portion of the mold cavity shown in FIG. 15.

FIG. 17 is a top section view of a mold with the apparatus for separating molded articles shown in FIG. 15.

### DETAILED DESCRIPTION OF PREFERRED AND OTHER EXEMPLARY EMBODIMENTS

FIGS. 11 and 13 show a molded article 10 (shown as a refuse container) formed by a molding machine 12 (shown as a blow molding machine) that is configured to separate or partially separate molded article 10 during the molding process. Molding machine 12 includes a mold 14 and an apparatus 16 configured to separate, partially separate, or assist in the separation (e.g., cut, sever, score, perforate, etc.) of molded article 10 into two or more pieces or components. Before proceeding further to the detailed description of the preferred and exemplary embodiments, several comments can be made about the general applicability and the scope thereof.

First, while the components of the disclosed embodiments will be illustrated as a method and apparatus designed for separating blow molded refuse containers, the features of the disclosed embodiments have a much wider applicability. For example, the method and apparatus is adaptable for other blow molded articles, such as storage units, bins, containers, and other office, home, or outdoor products that have multiple components that may or may not coact with or become attached to each other. Also, the method and apparatus is adaptable for other types of molding operations such as thermoforming, injection molding, casting, rotational molding, pressure or vacuum forming, and the like. Further, the size of the various molded articles can be widely varied.

Second, the particular materials used to construct the disclosed embodiments are also illustrative. For example, as will be appreciated by those familiar with the art, the refuse container components can be made from any of a variety of plastic resins, such as polypropylene, polyethylene, acrylonitrile butadiene styrene (“ABS”), any of a variety of homopolymer plastics, copolymer plastics, plastics with special additives, filled plastics, and a variety of other materials known to those familiar with the art. The method and apparatus is adaptable to separate any of such materials.

Proceeding now to descriptions of the preferred and exemplary embodiments, molded article 10 includes a main body 18 defining a cavity 20 and a secondary body (shown as a lid 22). Main body 18 of molded article 10 includes an open top defined by a rim 26, and a closed bottom defined by a bottom wall 28. Lid 22 includes a rim 30, which is configured to engage rim 26 of main body 18. Preferably, rim 30 of lid 22 is dimensioned to provide a frictional engagement with rim 26 of main body 18. According to an exemplary embodiment, body 18 and lid 22 are formed by a single blow molding operation.

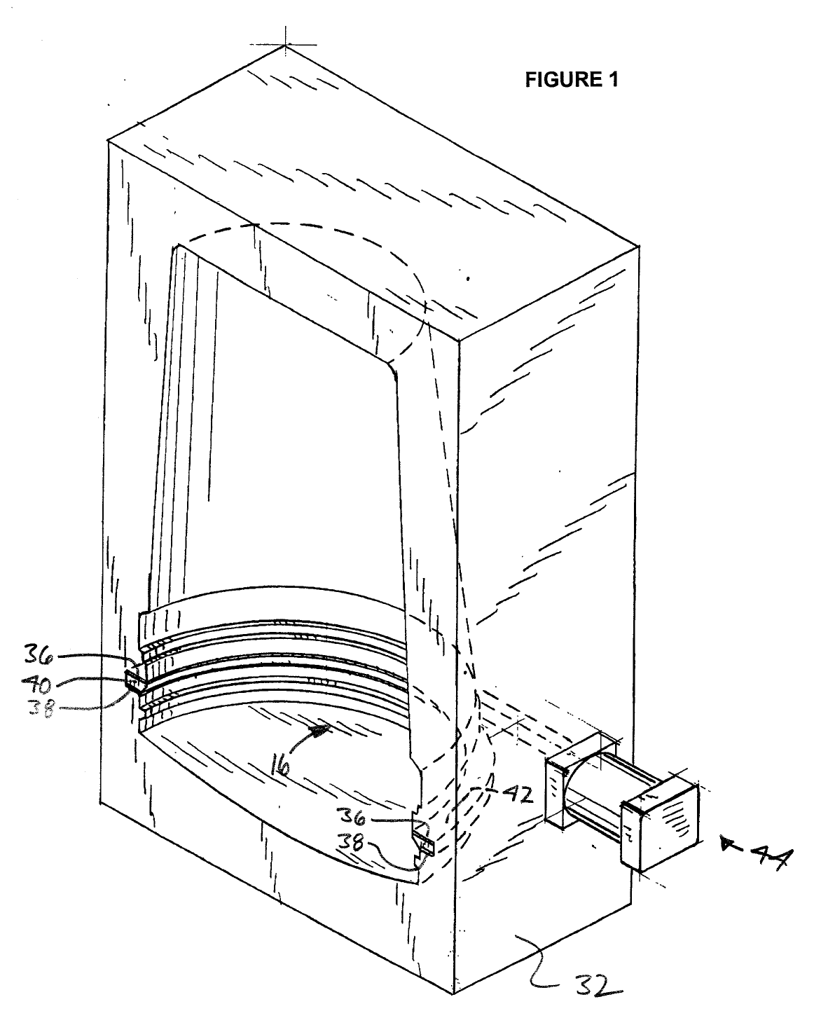

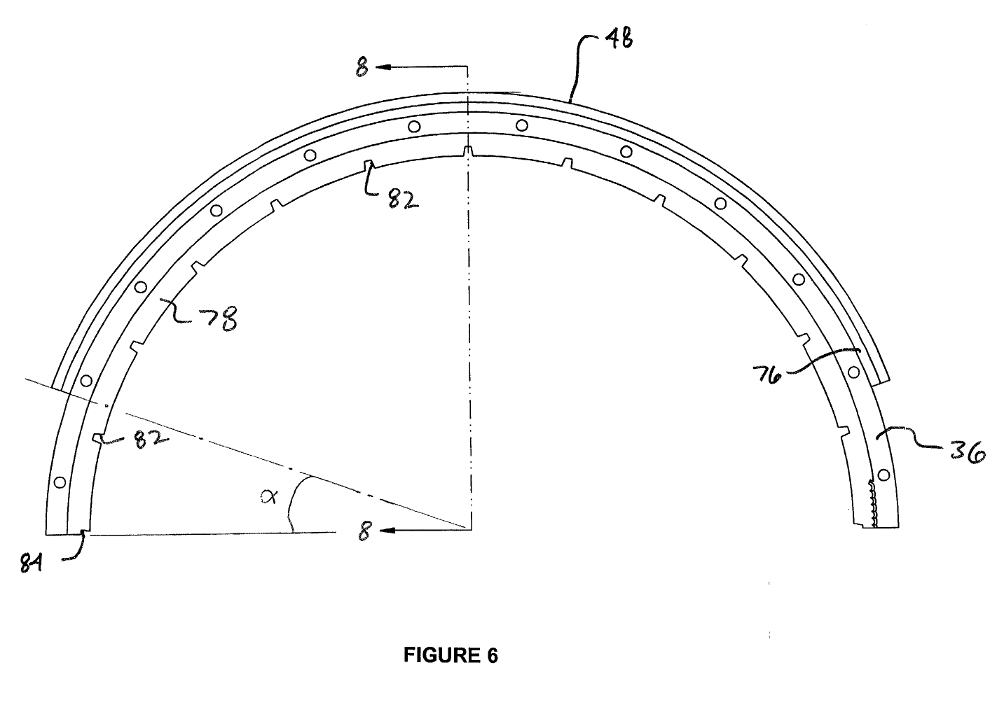

Referring to FIGS. 1, 5, and 6, mold 14 of molding machine 12 includes a pair of mold cavities 32, 34 that are configured to provide shape and texture to the blow molded article, and are moved between an open position and a closed position during the molding operation.

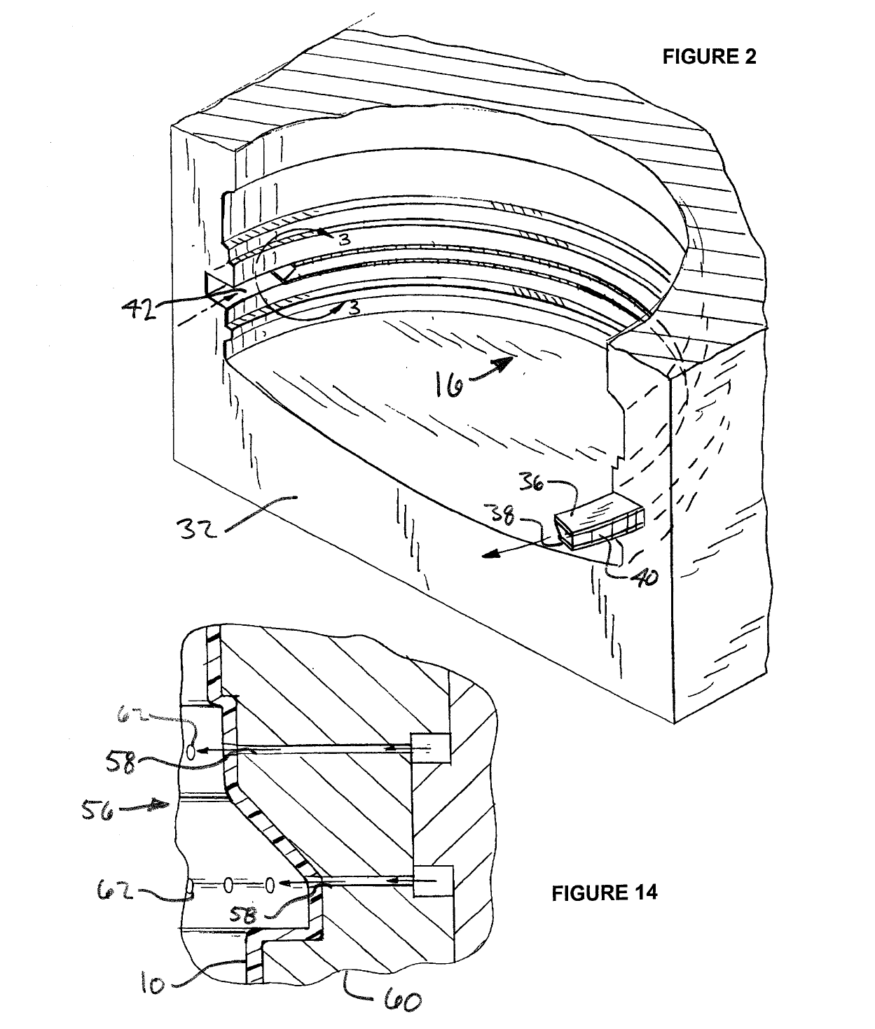

Referring to FIGS. 1 and 2, mold cavities 32, 34 include separating apparatus 16, which is configured to separate the blow molded article into two or more pieces or components. According to a preferred embodiment, separating apparatus 16 is configured to separate molded article 10 into two or more related components (e.g., lid 22 and body 18). These related components may be separate pieces of a larger assembly, or they may be configured to fit (or otherwise coact or engage) each other such as lid 22 that engages body 18. According to an alternative embodiment, a plurality of articles (identical or different) are molded and separated during the molding process.

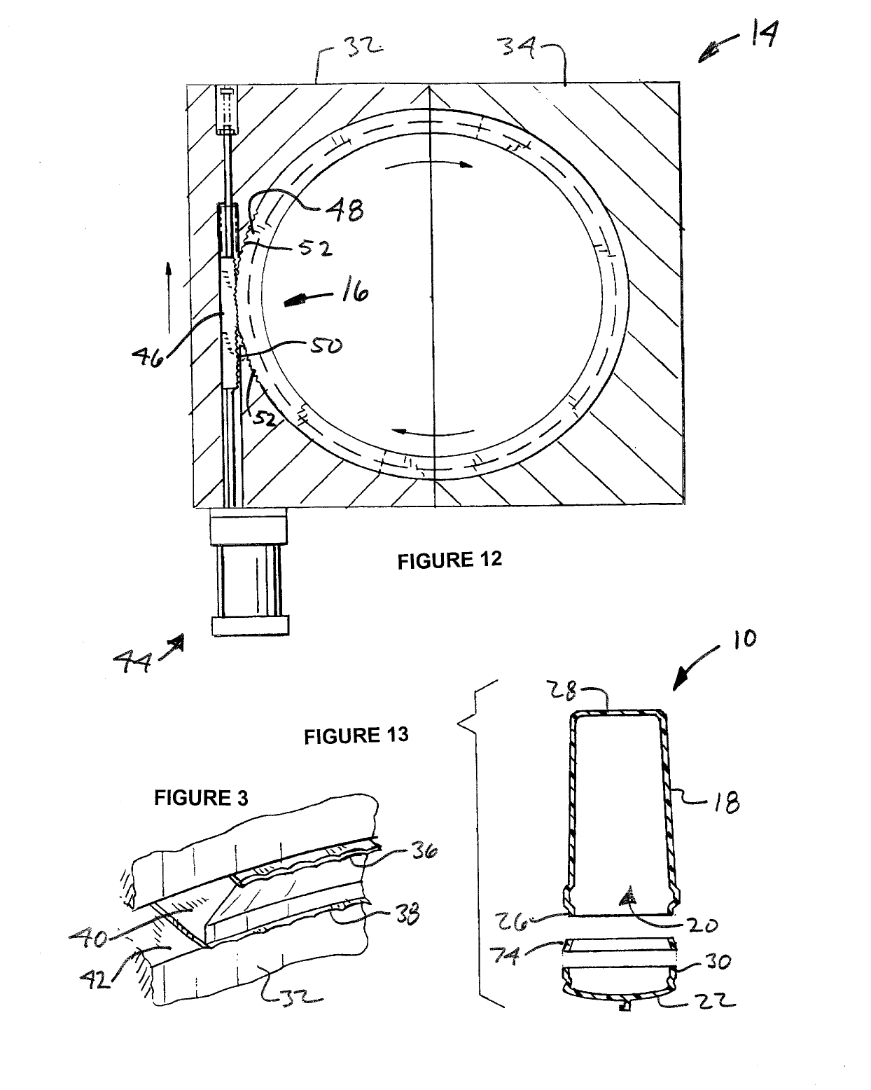

Separating apparatus 16 is disposed along the perimeter of mold cavities 32, 34. According to an alternative embodiment, separating apparatus 16 is disposed only partially along the perimeter (e.g., to effect a partial separation) or is located in only one of the mold cavities 32, 34. According to a preferred embodiment shown in FIGS. 2 and 3, separating apparatus 16 includes a pair of cutting members 36, 38 mounted to a base 40. Base 40 is located in a recess or channel 42 in mold cavity 32 or 34.

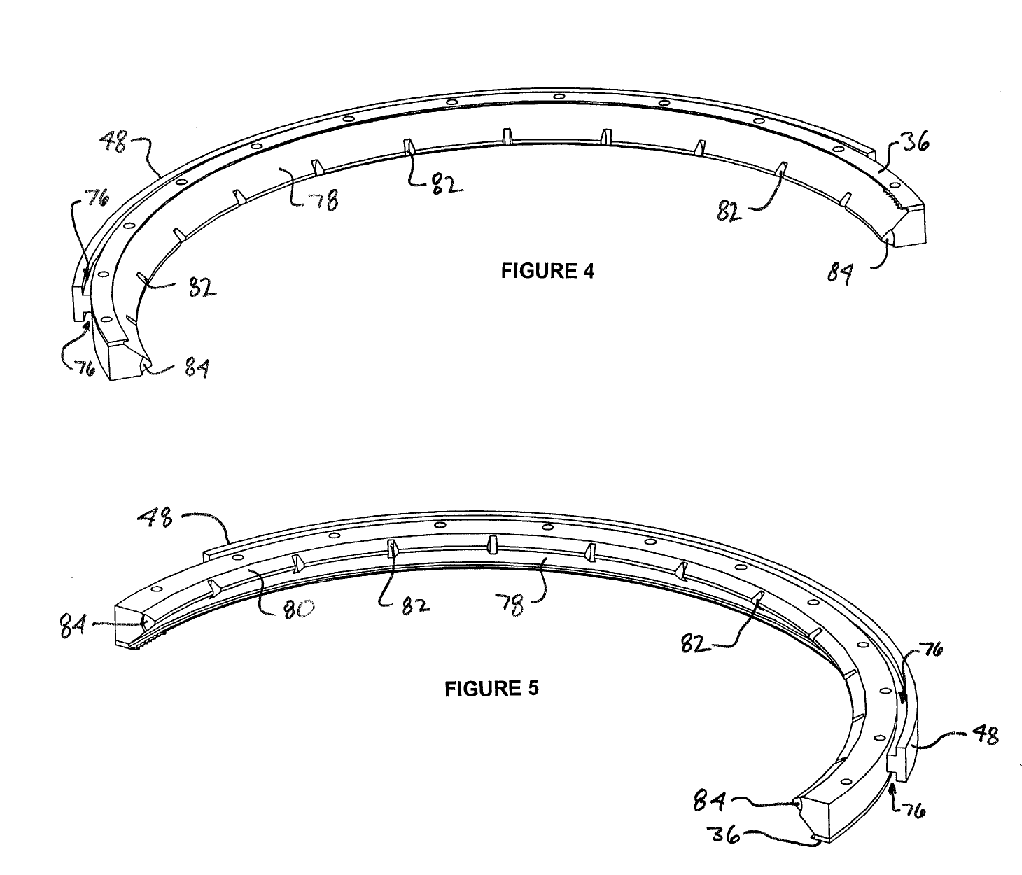

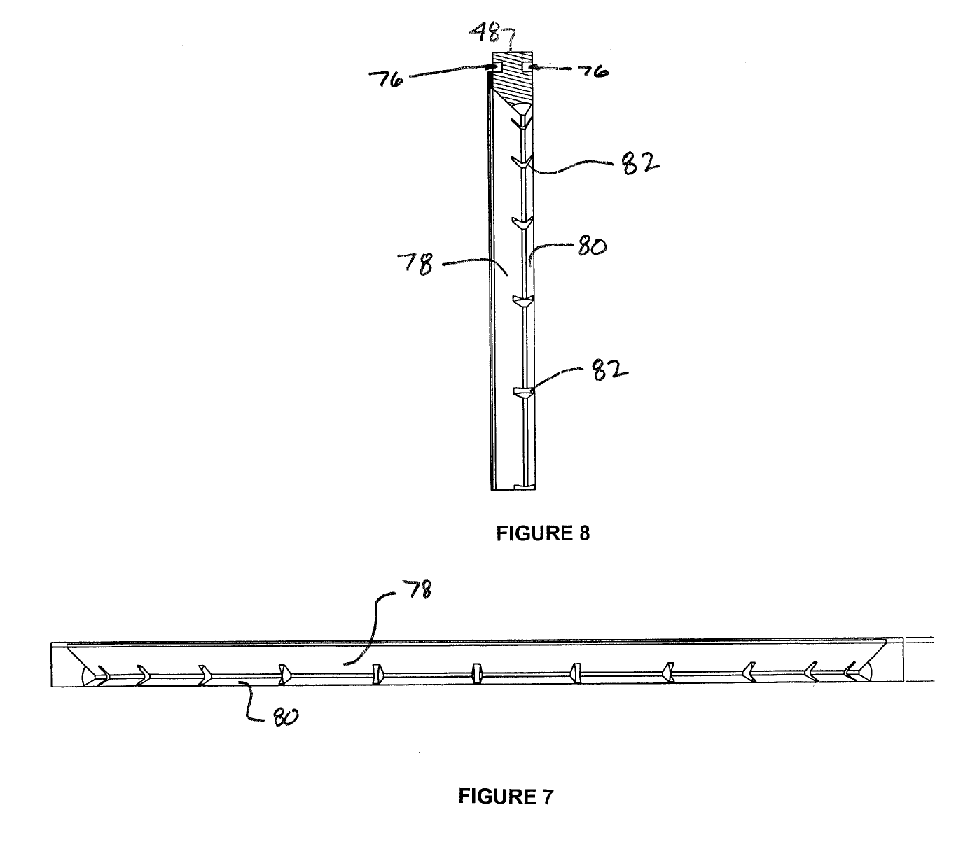

Referring to FIGS. 4-8, base 40 includes a retention member 48 configured to operatively couple separating apparatus 16 to mold cavity 32 or 34. Preferably, retention member 48 only partially extends about the outer perimeter of base 40 to provide clearance between retention member 48 (of one mold cavity 32) and the opposing mold cavity 34 (shown as an angle a). According to an exemplary embodiment, clearance α is between about 0° and about 90°. According to a preferred embodiment, clearance α is between about 5° and about 45°. According to a particularly preferred embodiment, separating apparatus 16 rotates 15° and clearance α is 20° at each end of base 40 to provide a safety factor of 5° on each end (i.e., retention member 48 spans about 140° and is centered about the perimeter). According to an alternative embodiment, the clearance α can be any of a variety of amounts and/or ranges.

According to a preferred embodiment, retention member 48 is “T”-shaped for secure engagement with cavity 32 or 34, and defines a pair of opposed channels 76. Channels 76 are configured to receive corresponding flanges in channel 42 in mold cavity 32 or 34.

Base 40 also includes a pair of ramped inwardly facing surfaces 78, 80. Surfaces 78, 80 face the interior of mold 14 and are exposed to molded article 10 during the molding operation. A notch 82 passes through surfaces 78, 80 and is configured to receive a portion of the plastic material during the molding operation. Expansion of the plastic material into notches 82 is configured to assist in the separation of molded article 10. Preferably, notches 82 are configured to cause a portion (e.g., the “trim band”) of molded article 10 to move as molded article 10 is being separated. Ends of base 40 include recesses 84 which form notches when located adjacent a similarly configured separating apparatus in the opposing adjacent mold cavity 34. According to alternative embodiments, any of a variety of designs, configurations, or arrangements can be used to cause a portion of the plastic material to move with separating apparatus 16 (e.g., recesses, tabs or ribs extending from base 40, and the like). Alternatively, the notches, recesses, tabs, or ribs are located on mold cavity 32 or 34 (rather than on, or in addition to, notches 82 on base 40) to inhibit movement of molded article 10 when separating apparatus 16 moves.

As shown in FIGS. 4 and 5, cutting member 36 is mounted to upper surface of base 40 (e.g., by fasteners such as screws, bolts, etc.). Cutting member 38 is similarly mounted to bottom surface of base 40. According to a preferred embodiment shown in FIGS. 3 and 9, cutting members 36, 38 include a serrated cutting surface. According to an alternative embodiment, cutting members 36, 38 have a smooth (i.e., non-serrated) cutting surface. Generally, the smooth cutting surface is preferred where it is desirable to have a cut surface or edge with an aesthetic appearance (e.g., those that are later viewed by a consumer). A serrated edge provides a better cutting action, which is preferred for thicker wall sections, or for a more efficient separating operation. Alternatively, cutting members 36, 38 have any of a variety of cutting surfaces or cross-sections, depending on the desired separating action, material, wall thickness, etc.

During the separating operation, cutting members 36, 38 are configured to cut or slice through the entire wall thickness. According to an exemplary embodiment, molded article 10 is cut along its entire perimeter (i.e., into two or more unattached pieces). Alternatively, molded article 10 is cut intermittently about its perimeter (i.e., “perforated” so that molded article 10 can later be pulled apart into two or more pieces) when it is desirable to maintain the molded article as one piece (e.g., during handling, post-molding operations, shipping, etc.) Alternatively, molded article 10 is cut or sliced partially through the wall thickness (e.g., “scored”) so that molded article 10 can later be pulled apart into two or more pieces.

According to a preferred embodiment shown in FIGS. 1 and 12, separating apparatus 16 is moved by an actuator 44. Actuator 44 includes a driving member 46 that is engaged with a driver member (shown as retention member 48) coupled to base 40 of separating apparatus 16. Preferably, driving member 46 and driver member form a rack and pinion engagement. Operation of actuator 44 moves driving member 46 so that gear teeth 50 of driving member 46 engage gear teeth 52 of retention member 48 to cause separating apparatus 16 to move or slide in channel 42 of mold cavity 32 and/or 34. As such, actuator 44 is operably coupled to base 40 and is configured to move separating apparatus 16 to separate or partially separate lid 22 from body 18.

Actuator 44 may be any of a variety of conventional actuator devices (e.g., pneumatic, hydraulic, cam-actuated, mechanical, electromechanical, etc.). Alternatively, separating apparatus 16 is manually moved (e.g., with a lever operated rack and pinion mechanism with a handle for the operator).

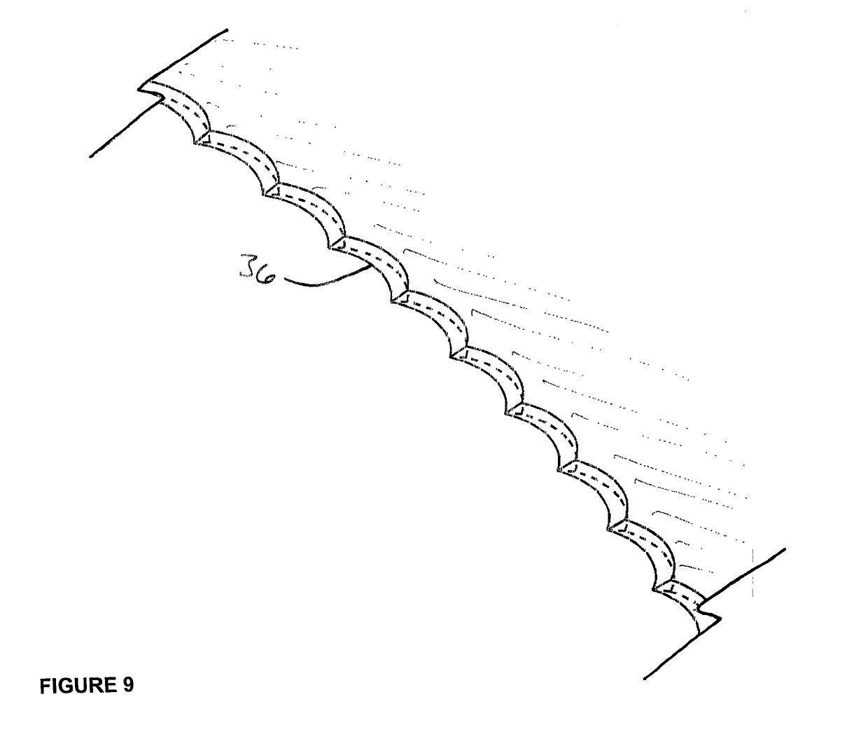

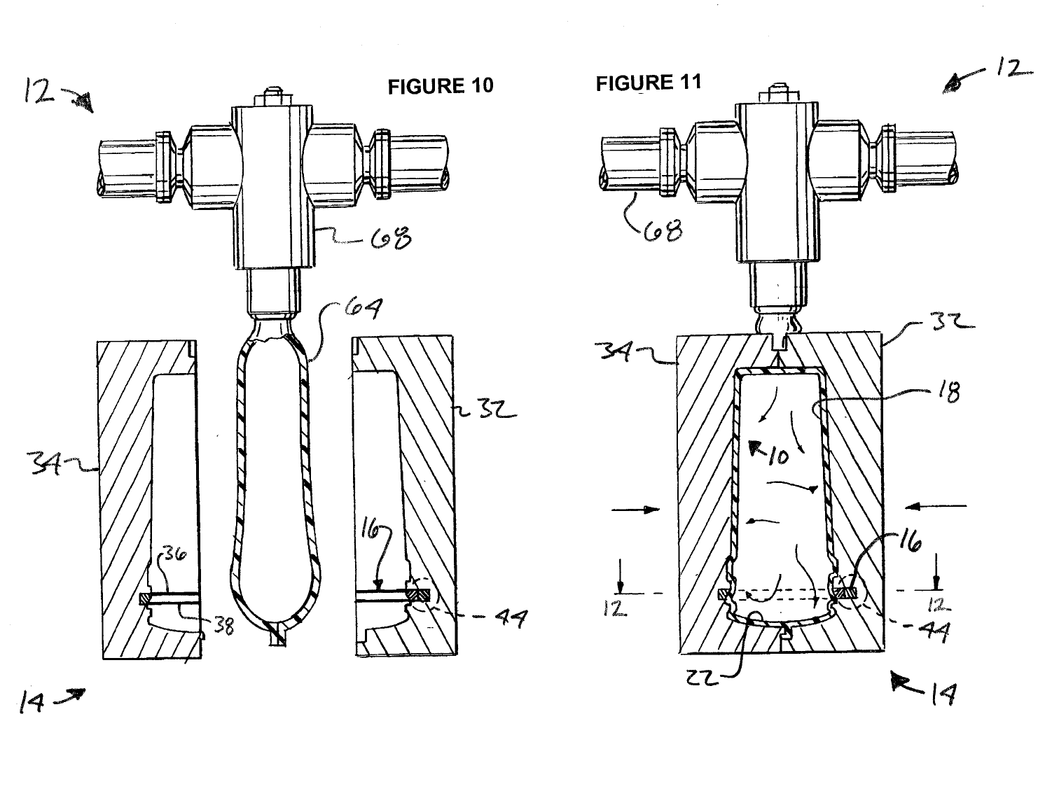

During the blow molding operation shown in FIGS. 10-12, a preform 64 (or “parison”) is supplied to mold 14 in the open position. Preform 64 generally includes a single wall and may be provided in any of a variety of configurations (e.g., planar, hollow, tubular shaped, etc.) depending on the desired molded article. For molding of the refuse container shown in FIG. 13, preform 64 is provided by an extrusion machine 68. When preform 64 has reached a required length and/or position, mold 14 is closed, excess material is removed or detached (e.g., “squeezed” off by edges of mold cavities 32, 34) and preform 64 is “sealed” by the formation of a weld or seam. A fluid is supplied (i.e., injected or blown) into the preform 64, expanding preform 64 within the mold 14 and against wall of mold cavities 32, 34. As preform 64 expands against mold cavities 32, 34, preform 64 adopts the configuration defined by the mold cavities 32, 34. The fluid may be any of a variety of known fluids used for blow molding, such as air, carbon dioxide, liquids, gases, etc. that may be stored under pressure and injected into preform 64. During the molding process, air is evacuated (from the space between mold 14 and preform 64) as preform 64 is “inflated” (preferably through vents disposed about mold 14).

After a predetermined time (determined by such factors as time, temperature of plastic material, pressure, etc.), separating apparatus 16 separates or partially separates molded article 10. According to an exemplary embodiment, separating apparatus 16 separates molded article 10 after the plastic material has at least partial solidified and before mold 14 is opened for removal of molded article 10. According to a preferred embodiment, separating apparatus 16 actuates during the exhaust step (i.e., as the fluid is withdrawn from preform 64). According to a particularly preferred embodiment, the fluid is only partially withdrawn so that pressure in preform 64 maintains engagement between preform 64 and notches 82. Alternatively, separating apparatus 16 separates molded article 10 after mold 14 has at least partially opened.

To separate or partially separate molded article 10, actuator 44 is signaled to actuate driving member 46, which actuates cutting members 36, 38 through meshed gear teeth 50, 52. Separating apparatus 16 moves along channel 42 and cutting members 36, 38 cut (or score, sever, slice, etc.) molded article 10 into two or more pieces (i.e., lid 22, a runner 74, and body 18). (Alternatively, actuator 44 is signaled to actuate based on an operator input or operation, such as a button or pedal.) Preferably, engagement between preform 64 and notches 82 causes the plastic material between cutting members 36, 38 to move with separating apparatus 16.

Referring to FIG. 13, molded article 10 includes lid 22, body 18, and a runner 74 (or “scrap ring or “trim band”). In the intended use of molded article 10, rim 30 of lid 22 is configured to engage rim 26 of body 18. During the molding operation, runner 74 is included to provide a transition or intermediate member so that rim 30 of lid 22 is sized to engage rim 26 of body 18. After molded article 10 is removed from mold 14, lid 22 and body 18 are separated from runner 74. Runner 74 can then be discarded, used as a component part, or recycled as plastic material for future molding operations. Alternatively, runner 74 is not included with molded article 10 and the component pieces are separated.

According to an alternative embodiment shown in FIG. 14, a separating apparatus 56 includes a plurality of apertures 58 (e.g., defined by nozzles, passages, or the like) located about the perimeter of mold cavity 60 and configured to force high velocity air into molded article 10 to rupture the plastic material (e.g., perforate) and partially separate molded article 10 along a perforation line 62. When molded article 10 is removed from mold 14, it can then be separated along perforation line 62.

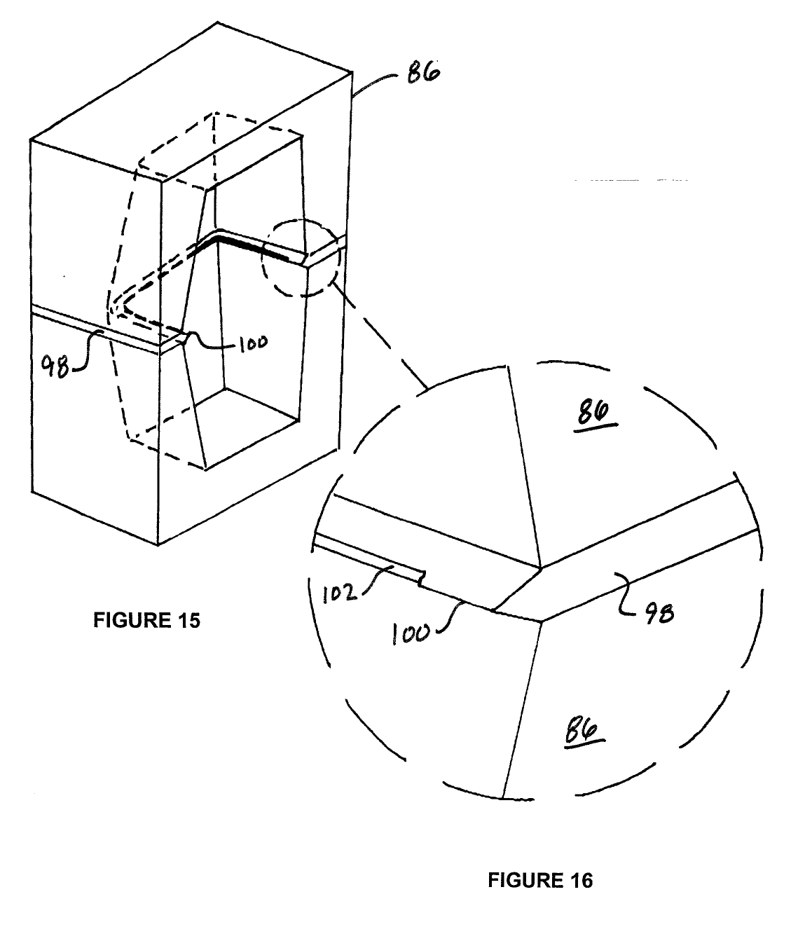

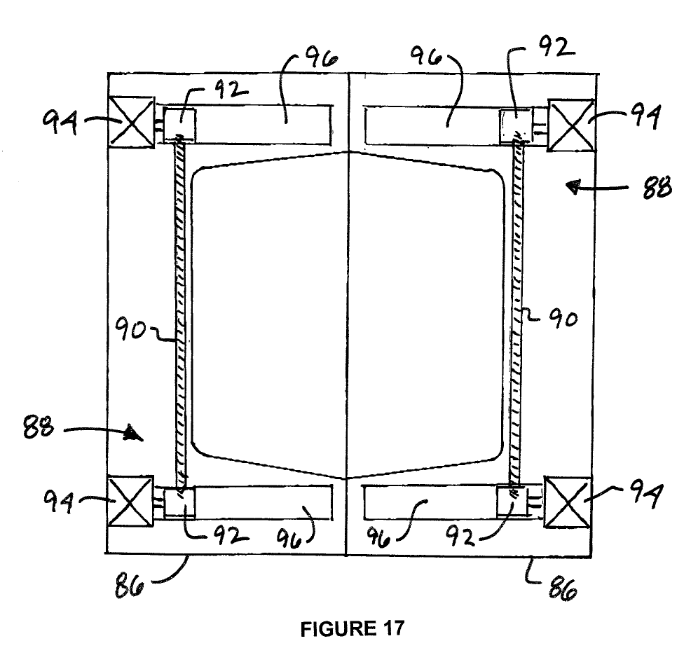

FIGS. 15-17 show a mold cavity 86 with an apparatus 88 for separating molded articles according to an alternative embodiment. Apparatus 88 includes a heated cutting element 90 mounted to a pair of runners 92. Heated cutting element 90 is configured to separate the molded articles by passing through the molded article by melting the plastic material. Heated cutting element 90 is moved by an actuator 94 (shown schematically as pneumatic or hydraulic cylinders) operatively coupled to runners 92. Preferably, cutting element 90 is heated by electric resistance generated by application of a current to cutting element 90. According to a particularly preferred embodiment, heated cutting element 90 is made from a nickel and chromium alloy (“nichrom”). Runners 92 are configured to move along a guide or channel 96 in mold cavities 86. Preferably, an intermediate cavity member 98 (or “blade”) is located at the point of separation. Cavity member 98 projects a sharp or pointed edge 100 into the interior mold cavity 86 thereby causing a reduced wall thickness in the plastic material being molded proximate edge 100 of cavity member 98. (The reduced wall thickness is intended to make it easier to cut or separate the molded article.) A slot 102 is located along the center of cavity member 98 and is configured to allow heated cutting element 90 to pass through as runners 92 move along channels 96.

At a prescribed time during the molding operation, separating apparatus 88 separates or partially separates the molded article when actuator 94 is signaled to move runners 92 along channel 96 such that heated cutting elements 90 move through slots 102. Separating apparatus 88 moves along channel 96 and heated cutting elements 90 melt the plastic material and cut (or sever, slice, etc.) the molded article into two or more pieces. (Alternatively, actuator 94 is signaled to actuate based on an operator input, such as a button or pedal.)

It is also important to note that the construction and arrangement of the elements of the method and apparatus for separating molded articles as shown in the preferred and other exemplary embodiments are illustrative only. Although only a few embodiments of the present invention have been described in detail in this disclosure, those skilled in the art who review this disclosure will readily appreciate that many modifications are possible (e.g., variations in sizes, dimensions, structures, shapes and proportions of the various elements, values of parameters, mounting arrangements, materials, colors, orientations, etc.) without materially departing from the novel teachings and advantages of the subject matter recited in the claims. For example, the separating apparatus and method may be used with a variety of molding or casting operations. Also, a variety of separating devices can be used including cutting, forced air, and the like. Further, any of a variety of actuators can be used to actuate separating apparatus. Accordingly, all such modifications are intended to be included within the scope of the present invention as defined in the appended claims. The order or sequence of any process or method steps may be varied or re-sequenced according to alternative embodiments. In the claims, any means-plus-function clause is intended to cover the structures described herein as performing the recited function and not only structural equivalents but also equivalent structures. Other substitutions, modifications, changes and/or omissions may be made in the design, operating conditions and arrangement of the preferred and other exemplary embodiments without departing from the spirit of the present invention as expressed in the appended claims.

What is claimed is:

1. A method of making molded components, the method comprising:
supplying a plastic material to a mold to form a molded article;
moving a separating apparatus located in the mold to at least partially separate the molded article into at least two components.

2. The method of claim 1 further including the step of opening the mold after actuating the separating apparatus.

3. The method of claim 1, further including the step of pulling the at least partially separated molded article apart into two or more pieces.

4. The method of claim 1, wherein the separating apparatus is moved by an actuator.

5. The method of claim 4 wherein the actuator is one of a mechanical actuation device, a pneumatic actuation device, a hydraulic actuation device, an electromechanical actuation device, and a manual actuation device.

6. The method of claim 4 wherein the actuator is coupled to the separating device by one or more gears.

7. The method of claim 6 wherein the actuator is a rack and pinion.

8. The method of claim 1 wherein the molded article is formed by blow molding.

9. The method of claim 1 wherein the separating apparatus includes one or more cutting members.

10. The method of claim 9 wherein a cutting member includes a serrated surface.

11. The method of claim 9 wherein a cutting member includes a non-serrated surface.

12. The method of claim 1 wherein the components are non-similar.

13. The method of claim 12 wherein the components are a container and a lid.

14. The method of claim 1 wherein the components are similar.

15. The method of claim 1 further including separating the molded article into a first portion, a second portion, and a third portion, wherein the second portion moves with the separating apparatus.

16. The method of claim 15 further including the step of gripping the secondportion so that it moves with the separating apparatus.

17. The method of claim 16 wherein the separating apparatus includes a plurality of notches configured to grip the second portion.

18. The method of claim 1 wherein the separating apparatus includes one or more heated cutting elements.

19. The method of claim 18 further including the moving one or more heated cutting elements through the interior of the mold.

20. The method of claim 18 further including heating the one or more heated cutting elements by electrical resistance.

21. The method of claim 18 wherein the one or more heated cutting elements separates the molded article by melting the plastic material.

22. A method of making a molded article having a first portion and a second portion, the method comprising:
forming the molded article in a mold;
at least partially separating the first portion from the second portion; and then
opening the mold.

23. The method of claim 22 wherein the at least partially separating step includes moving one or more cutting members against the molded article.

24. The method of claim 22 wherein the at least partially separating step includes directing high velocity air at the plastic material.

25. The method of claim 22 wherein the at least partially separating step includes perforating the molded article.

26. The method of claim 22 wherein the at least partially separating step includes cutting the molded article into two or more portions.

27. The method of claim 22 wherein the at least partially separating step includes scoring the molded article.

28. An apparatus for making molded components, the apparatus comprising:
a cavity configured to provide the desired shape of a molded article; and
a separating apparatus coupled to the cavity and configured to at least partially separate the molded article into at least two pieces.

29. The apparatus of claim 28 wherein the separating apparatus includes a cutting member.

30. The apparatus of claim 29 wherein the cutting member includes a serrated cutting surface.

31. The apparatus of claim 29 wherein the cutting member includes a non-serrated cutting surface.

32. The apparatus of claim 29 wherein the cutting member includes two or more cutting surfaces.

33. The apparatus of claim 28 wherein the separating apparatus includes two or more cutting members.

34. The apparatus of claim 28 wherein the separating apparatus is actuated by an actuator.

35. The apparatus of claim 34 wherein the actuator is one of a mechanical device, a hydraulic device, a pneumatic device, an electromechanical device, and a manual device.

36. The apparatus of claim 28 wherein the cavity includes a channel and the separating apparatus includes a base disposed within the channel.

37. The apparatus of claim 36 wherein the separating apparatus includes an actuator configured to move the base in the channel.

38. The apparatus of claim 36 wherein the channel is disposed along the perimeter of the cavity.

39. The apparatus of claim 38 wherein the actuator is coupled to the separating device by one or more gears.

40. The apparatus of claim 39 wherein the actuator includes a rack and pinion.

41. The apparatus of claim 28 wherein the separating apparatus includes a plurality of apertures disposed along a perimeter of the cavity and configured to force high velocity air into the cavity.

42. The apparatus of claim 41 wherein the high velocity air is configured to perforate the molded article.

43. The apparatus of claim 28 further including one or more notches configured to grip the molded article.

44. The apparatus of claim 43 wherein the notches are located on the separating apparatus.

45. The apparatus of claim 28 wherein the separating apparatus at least partially separates the molded article into a first portion, a second portion, and a third portion, the second portion being configured to move with the separating apparatus.

46. The apparatus of claim 28 wherein the separating apparatus includes one or more heated cutting elements.

47. The apparatus of claim 46 wherein the one or more heated cutting elements are heated by electrical resistance.

48. The apparatus of claim 46 wherein the one or more heated cutting elements separates the molded article by melting the plastic material.
